(19) United States
(12) Patent Application Publication
(10) Pub. No.: US 2026/0204958 A1
(43) Pub. Date: Jul. 16, 2026

(54) COMPACT TWO-PHASE MOTOR

(71) Applicant: Moving Magnet Technologies, Besançon (FR)

(72) Inventors: Lionel Billet, Dannemarie sur Crète (FR); Damien Laforge, Dannemarie sur Créte (FR)

(21) Appl. No.: 19/134,399

(22) PCT Filed: Nov. 29, 2023
(86) PCT No.: PCT/EP2023/083616

§ 371 Date: May 30, 2025

(30) Foreign Application Priority Data
Nov. 30, 2022 (FR) FR2212543

(51) Int. Cl. H02K 1/14; H02K 7/06

(52) U.S. Cl. CPC H02K 1/14; H02K 7/06; H02K 2213/03

(57) ABSTRACT

A two-phase brushless electric motor has a rotor and a stator, the stator including a stack of cut ferromagnetic laminations having two teeth each extending along a median radial axis, the median radial axes being coplanar. The cross-section of the stator is inscribed within a rectangle having a length L₁ and a width L₂. Each of the teeth is surrounded by an electrical coil. The rotor comprises three, four or five pairs of magnetic poles, which are radially magnetized in alternating directions. The median radial axes form an angular sector therebetween that extends over an angle of between 145° and 180° and the stator has at least one mechanical and magnetic continuity extending between the two wound teeth.

### CROSS-REFERENCE TO RELATED APPLICATIONS

This application is a national phase entry under 35 U.S.C. § 371 of International Patent Application PCT/EP2023/083616, filed Nov. 29, 2023, designating the United States of America and published as International Patent Publication WO 2024/115606 A1 on Jun. 6, 2024, which claims the benefit under Article 8 of the Patent Cooperation Treaty of French Patent Application Serial No. FR2212543, filed Nov. 30, 2022.

### TECHNICAL FIELD

The present disclosure relates to a two-phase brushless electric motor, in particular, a motor integrated into a mechatronic system. In particular, the present disclosure relates to automotive peripherals with very tight space constraints, such as expansion valves or the actuation of air flow diverter flaps in an air conditioning module.

### BACKGROUND

An example of such a motor is described in the patent FR2742940B1, which proposes a two-phase motor consisting of a stator part excited by two electric coils and a magnetized rotor with N pairs of poles magnetized radially in alternating directions, N being equal to 3 or 5. The stator section features at least two W-shaped circuits, each with an electric coil surrounding the central leg. The W-shaped circuits are arranged so that when one of the central legs faces a magnetic transition, the other central leg faces a magnetic pole. The pole shoes of the legs of a W-circuit are angularly spaced apart by π/4 and the pole shoes of the central legs of two W-circuits belonging to different phases are angularly spaced apart by an angle substantially equal to π/2±k·π/N, where N is the number of magnetic pole pairs, either 3 or 5 and k is equal to 0, 1, or 2.

Other similar motors are known, for example, from patent EP1713166 describing a drive device comprising a stator, a rotor comprising a core formed from a soft magnetic material and a shaft mounted in the core, a magnet having a cylindrical shape and being magnetized so that different poles alternate in a circumferential direction. A first coil is wound around the first external magnetic pole portion via the coil at an axial location between the magnet and the base. A second coil is wound around the second external magnetic pole portion via the coil at an axial location between the magnet and the base.

The needle valve described in patent EP2484948A1 comprises a housing formed with a first port communicating with one end portion of a cylindrical communication hole, and a second port communicating with the other end portion of the communication hole; a needle valve stem, which is movably mounted in an axial direction in the communication hole, and which is formed with a tapered portion whose outer diameter has changed in a direction from one end portion side toward the other end portion side of the communication hole, and a gap between the tapered portion and a valve seat surface of the communication hole is changed according to a position thereof in the axial position.

Patent US2017338113 describes a motor comprising a stator and a rotor rotatably disposed in the stator, the rotor comprising a rotatable shaft and a gearbox driven by the motor, the gearbox comprising a housing wherein the motor is mounted, and a gear mounted on the housing and driven by the rotatable shaft of the motor, two first bearings mounted in the housing on the same side of the stator to support the rotatable shaft and allow the stator to pivot relative to the housing.

### BRIEF SUMMARY

It has become apparent that the various geometries proposed in the prior art lead to solutions penalized by a relatively high residual no-current torque CO and a footprint in one of the directions belonging to the plane perpendicular to the axis of rotation, for a given power, which can be improved and restricted. In particular, prior art solutions featuring “W”-shaped magnetic circuits are unsatisfactory in terms of no-current torque when only the wound teeth form an angle of more than 120° and their magnetic circuits are magnetically connected, resulting in interactions between these magnetic circuits that adversely affect no-current torque.

Some prior art solutions also have the disadvantage of requiring complex stator shapes that are incompatible with conventional techniques for stacking thin ferromagnetic laminations, such as costly 3D lamination forming or multi-part assembly.

The present disclosure aims to address these drawbacks. To this end, the present disclosure relates in its most general scope to a two-phase brushless electric motor.

The motor has a rotor and a stator, the stator including a stack of cut ferromagnetic laminations having two teeth each extending along a median radial axis, the median radial axes being coplanar, the cross-section of the stator being inscribed within a rectangle having a length L₁ and a width L₂, each of the teeth being surrounded by a coil. The rotor includes three, four or five pairs of magnetic poles, which are radially magnetized in alternating directions. The median radial axes form an angular sector therebetween that extends over an angle of between more than 145° and less than 180°. The stator has at least one mechanical and magnetic continuity extending between the two wound teeth.

Embodiments of the present disclosure may also have one or a compatible combination of the following features.

In particular, the median radial axes form an angle of 157.5° with one another, the rotor having 4 pairs of poles.

Alternatively, the median radial axes form an angle of 162° with one another, the rotor having 5 pairs of poles.

In another alternative, the median radial axes form an angle with one another such that the two coils are electrically phase-shifted by 120°.

In a first variant, the yoke has a second mechanical and magnetic continuity, one or other of the mechanical and magnetic continuities forming at least one continuous unwound tooth, the first and second mechanical and magnetic continuities extending on either side of the rotor between the two wound teeth, the first and second mechanical and magnetic continuities being of different angular widths.

In particular, for this first variant, the second of the mechanical and magnetic continuities forms a single continuous unwound tooth.

According to this variant, the median radial axis of each of the continuous unwound tooth or teeth can be located equidistant from the median radial axes.

Also according to this variant, the angular width of the continuous unwound tooth or teeth can be between 60° and 130°.

In another variant, a mechanical and magnetic continuity forms two unwound teeth, the median radial axis of each of the unwound teeth forming an angle greater than 45° with the median radial axis of the nearest wound tooth.

In another variant, the mechanical and magnetic continuity forming two unwound teeth is located in the least extended angular sector separating the median radial axes.

Alternatively, the yoke has a discontinuity extending between the two wound teeth on the opposite side to the mechanical and magnetic continuity.

In another variant, the ratio between the diameter D of the rotor and the length L₁ is greater than 50%.

In one variant, the ratio of width L₂ to length L₁ of the stator outer casing is between 0.4 and 0.6.

In particular, the ratio between width L₂ and length L₁ of the stator outer casing is between 0.4 and 0.5.

In one variant, the rotor is coupled to a worm screw forming the first module of a motion transformation system.

In particular, the motion transformation is of the rotary-linear type, controlling the linear displacement of an output member.

More precisely, the member is a needle.

Alternatively, the transformation of motion is a linear displacement collinear with the rotor axis.

In another alternative, the motion transformation is of the rotary-rotary type, controlling the rotation of an output shaft.

In one variant, the output shaft is oriented in a direction perpendicular to the direction of the axis of the rotor.

The present disclosure also relates to a mechatronic system comprising a brushless electric motor and a substantially parallelepiped housing, characterized in that the motor conforms to one of the preceding variants and in that the rotor axis is oriented along the long length of a parallelepiped casing delimiting the housing.

In particular, the mechatronic system includes a printed circuit board arranged between the motor and the housing, the face of the motor printed circuit board having a connector passing through a cutout provided in the transverse face of the housing.

### BRIEF DESCRIPTION OF THE DRAWINGS

The present disclosure will be better understood on reading the following description, which concerns a non-limiting exemplary embodiment that is shown by the appended drawings, in which:

FIG. 1 shows a front view of a first example of a motor according to the present disclosure with 4 pairs of magnetized poles;

FIG. 2 shows a front view of a second example of a motor according to the present disclosure with 5 pairs of magnetized poles;

FIG. 3 shows a front view of a third example of a motor according to the present disclosure with a magnetic and mechanical discontinuity;

FIG. 4 shows a front view of a fourth example of a motor according to the present disclosure;

FIG. 5 shows a front view of an example of integration of the motor according to the present disclosure in a shutter mobilization actuator, with the actuator housing stripped of its cover;

FIG. 6 shows a cross-section orthogonal to the rotor axis of the actuator shown in the previous figure;

FIG. 7 shows a cross-sectional view AA′ of the actuator shown in FIG. 5;

FIG. 8 shows a front view of an example of integration of the motor according to the present disclosure in an expansion valve actuator;

FIG. 9 shows a lateral cross-sectional view of the actuator shown in the previous figure;

FIG. 10 shows a cross-section orthogonal to the rotor axis of the valve actuator shown in FIG. 8, with the housing stripped of its cover; and

FIG. 11 shows a perspective view of a variant with two linked stators.

### DETAILED DESCRIPTION

### General Principle of the Present Disclosure

The aim of the present disclosure is to provide an easy-to-manufacture, high-performance and compact two-phase electric motor. In particular, it relates to a motor with a form factor perpendicular to the axis of rotation of the rotor optimized for integration in a compact housing with positioning of the rotor axis perpendicular to the cross-sectional plane of the housing.

For certain mechatronic applications (grill shutter actuators, fluidic valves, etc.), the form factor required for optimum integration of the motor into the actuator housing implies, in the cross-section of the motor (orthogonal to its axis of rotation), a dimension along one axis that is much smaller than the dimension along the other axis, resulting in motors that are rather elongated and have a substantially tubular casing, but differ from the long-form motors of the prior art in that the axis of rotation of the rotor is orthogonal to the long length of the casing and located close to the middle along this long length. In the following, motor width refers to the smallest motor dimension in the cross-section, length refers to the largest motor dimension in the cross-section, and thickness refers to the dimension in the direction orthogonal to the cross-section.

In a particular application for automotive air-conditioning flap control, the stator plane perpendicular to the axis of rotation is inscribed in the smallest cross-section of the actuator.

However, these dimensional constraints must preserve the motor's performance in terms of torque and electromechanical efficiency, and by reducing the residual torque in the absence of current observed in prior art solutions.

For this purpose, the motor according to the present disclosure comprises a stator with only two wound teeth, the first carrying a first coil fed by a first phase, and the second carrying a second coil fed by the opposite phase of the two-phase supply. The angle formed between the median radial axes of the two teeth is between 155° and 150° when the rotor has 4 pairs of poles, or between 160° and 165° when the rotor has 5 pairs of poles, or an angle such that the two coils are electrically out of phase by 120°.

### Geometrical Features of the Motor According to the Present Disclosure

The two-phase electric motor (1) according to the present disclosure comprises a rotor (10) and a stator (20) fitted with two coils (31, 32) each connected to a different electrical phase supplying the two-phase motor. The stator (20) is formed by a stack of ferromagnetic thin laminations all having the same cutout, symmetrical with respect to a transverse median plane P. The laminations, seen in the lamination plane, are provided with a closed peripheral belt (40), inscribed in a rectangular casing (50) of length L₁ and width L₂, and have cutouts to form two teeth (21, 22) intended to carry the two electrical coils (31, 32). These two teeth (21, 22) are oriented radially with respect to the rotor (10) and extend along two coplanar axes (A₁, A₂) angularly separated by an angle greater than 145°, so as to form two complementary angular sectors (α₁, α₂). In at least one of the angular sectors (α₁, α₂), the teeth (21, 22) are connected by a peripheral belt so as to ensure at least mechanical and magnetic continuity (41, 42) between the wound teeth (21, 22). The angular separation of the wound teeth (21, 22), at a very open angle, minimizes the stator's radial footprint in the angular sectors (α₁, α₂) within which the laminations are cut to the strict minimum required to ensure a good magnetic connection with the rotor and guarantee the stator assembly's mechanical strength.

The lamination plane of the laminations is a plane orthogonal to the thickness of the lamination, that is, the smallest dimension of the lamination before any cuts. The laminations are stacked in a direction orthogonal to this plane to form a lamination pack.

The rotor (10) has a diameter D, and is inscribed in the rectangular casing (50) of the stator laminations so that the ratio of rotor diameter to stator width is greater than 50%. The rotor has N magnetized poles (11, 12), with N being 6, 8 or 10, distributed around its periphery in alternating directions, to form North poles (11) and South poles (12). These poles are preferably produced in a monolithic magnet ring molded onto a cylindrical core, but could alternatively be obtained by any other technique known to the skilled person, such as press-fitting a ring, gluing magnetized tiles or even, in a non-limiting way, by magnetizing an injected magnet constituting a monolithic rotor.

The length of the wound teeth (21, 22) is carefully chosen to be compatible with the construction of the electrical coils (32, 32) on coil bodies, which are then inserted on the teeth (21, 22) of the laminated core through the internal space freed to accommodate the rotor (10). The length of the wound teeth (21, 22) must therefore be less than the rotor diameter, D, plus twice the magnetic air gap, e, which corresponds to the difference between the tooth face and the outer periphery of the rotor.

### First Variant Embodiment

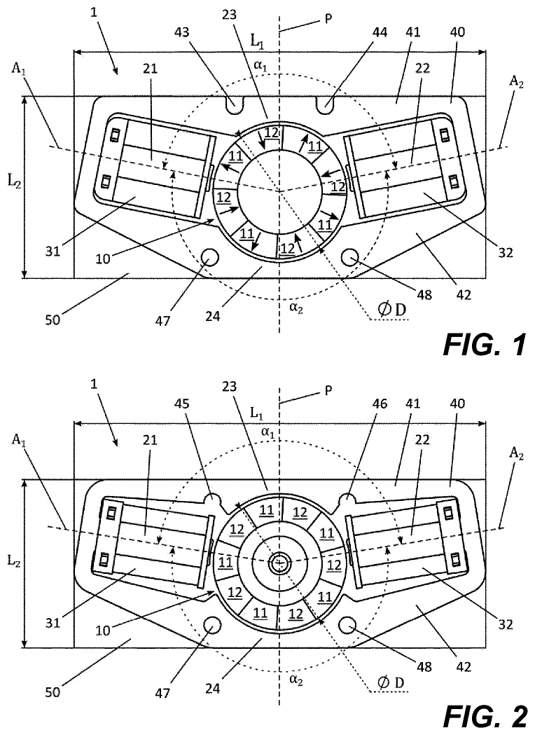

FIG. 1 shows a first variant of the present disclosure with an 8-pole magnetic rotor (11, 12). To optimize magnetic performance, the axes (A₁, A₂) of the wound teeth (21, 22) are angularly separated by 157.5°, which is the most open angle allowing perfect magnetic quadrature between the wound teeth (21, 22). Thus, when one of the two teeth (21, 22) faces a transition between two magnetized poles (11, 12) of the rotor, the other faces the middle of another magnetic pole. In order to ensure good magnetic flux feedback, the wound teeth (21, 22) are connected by mechanical and magnetic continuities (41, 42) in each of the angular sectors (α₁, α₂), whose cross-section, w, that is, thickness in the lamination plane of the laminations, must be sufficient to ensure the passage of magnetic flux without saturation, and is therefore equivalent to half the width of the wound teeth (21, 22). This constraint defines the stator's maximum overall dimensions and therefore the length L₁ and width L₂ of the rectangular casing (50).

These parameters can be written as a function of the motor sizing variables, giving:

$${L}_{1} = 2 \times \text{?} cos ( 90 - θ ) + {B}_{2} sin ( 90 - θ ) , and$$

$${L}_{2} = \text{?} sin ( 90 - θ ) + \frac{{B}_{2}}{2} cos ( 90 - θ ) + \frac{D}{2} + w + e ,$$

$$\text{?} \text{indicates text missing or illegible when filed}$$

where θ is half the smallest angle between the axes (A₁, A₂), B₁ is the length between the rotor's center of rotation and the bottom of a wound tooth (21, 22) and B₂ is the width of the tooth bottom.

These last two values are written as:

$$\text{?} = \frac{D}{2} + \text{?} + w + e , et$$

$${B}_{2} = 3 \times w + 2 \times {l}_{s} ,$$

$$\text{?} \text{indicates text missing or illegible when filed}$$

where lₛ is the width of the winding slots and l is the length of a tooth, with the following constraint on coil insertion:

$$1 \leq D + 2 \times e .$$

The width of the teeth (21, 22), that is, 2×w, is preferably determined in relation to the opening angle, P, of the front of the teeth (21, 22) and gives the relationship:

$$w = ( \frac{D}{2} + e ) \times tan ( \frac{β}{2} ) .$$

Finally, the width of the slots, lₛ, is set by the end of the face of the nearest unwound tooth; the angle formed between the tooth center and this end is called γ, and the following is obtained:

$${l}_{s} = ( \frac{D}{2} + e ) \times sin ( γ ) - w .$$

Preferably, the angles β and γ are chosen such that:

$$14 ° \leq β \leq 30 ° , and$$

$$35 ° \leq γ \leq 65 ° ,$$

and so as to comply with the ratios:

$$0 \text{?} 4 \leq \text{?} \leq 0 \text{?} 6 \text{?} and$$

$$\text{?} \geq 0 \text{?} 5.$$

$$\text{?} \text{indicates text missing or illegible when filed}$$

Compared with the state of the art in asymmetrical two-phase motors, which prefer closed angles, often equal to 90°, this configuration has the advantage of better balancing magnetic forces and therefore limiting vibrations linked to force variations between the rotor and the stator.

In order to minimize no-current torque, and again with the aim of minimizing vibration, the mechanical and magnetic continuities (41, 42) each feature a protrusion extending toward the rotor to form a highly flared unwound tooth (23, 24), the unwound teeth (23, 24) flaring angularly over most of the angular sectors (α₁, α₂), leaving only the space required for the slots accommodating the electrical coils (31, 32) supported by the teeth (21, 22). Since the angular sectors (α₁, α₂) are of different widths, the faces of the unwound teeth (23, 24) spread over different angular extents, but greater than 60°, while the wound teeth (21, 22) instead have a tooth face spreading over an angle of 20°. The resulting two-phase motor has a virtually smooth air gap, notched only around the teeth (21, 22) to accommodate the coils (31, 32).

Note that this wide-tooth configuration makes it possible to notch the outer periphery of the magnetic and mechanical continuity (41) located in the most closed angular sector (α₁). The notches (43, 44) thus created allow the stator (20) to be secured without protruding beyond the rectangular casing (50), while leaving a sufficient cross-section for the passage of magnetic flux through the mechanical and magnetic continuity (41). The angular sector (α₂), which is the most open, offers more space to ensure mechanical strength without protruding beyond the rectangular casing (50), so that the second magnetic and mechanical continuity (42) can have a larger cross-section to be provided with holes (47, 48) to ensure very precise positioning of the stator and its support, while offering a sufficient cross-section for passage of the magnetic flux.

Of course, the angle of 157.5° between the axes (A₁, A₂) of the wound teeth (21, 22) is optimal for two-phase control of the two coils. However, the skilled person could imagine modifying this angle to serve different purposes. For example, the angle could be slightly modified to deliberately degrade magnetic performance in terms of torque density, but to improve no-current torque. An alternative motivation would be to achieve three-phase drive using only two coils. The two coils can in fact be powered together to emulate the missing coil of the three-phase drive. The wound teeth (21, 22) must then be arranged so as to obtain an electrical angle of 120° between the coils. This means that the voltage induced by rotor rotation produces signals at the terminals of the two windings that are 120° out of phase. The angle between the axes (A₁, A₂) of the wound teeth (21, 22) would then be 165°, so as to obtain optimum steering compatible with the present disclosure. Of course, we misuse the term “three-phase control,” as the electrical vectors correspond to this type of control, but we remain within the framework of a two-phase motor for which only two windings are supplied.

### Second Variant Embodiment

FIG. 2 shows a second variant according to the present disclosure. It differs from the previous design in that the rotor is fitted with 10 magnetized poles (11, 12). To keep the teeth (21, 22) wound in phase quadrature, the angle between the axes (A₁, A₂) is increased to 162°. This configuration results in an even flatter motor than the version shown in FIG. 1 with 8 magnetized poles (11, 12).

A direct result is that the outer periphery of the mechanical and magnetic continuity (41), located in the most closed angular sector (α₁), is closer to the rotor. The cross-section of the mechanical and magnetic continuity (41) is therefore smaller and no longer allows notching of its outer periphery, as shown in FIG. 1, without impacting the passage of the magnetic flux or without the cylindrical attachment means protruding from the rectangular casing (50). Conversely, notches (45, 46) can be made at the inner periphery of the mechanical and magnetic continuity (41) to meet the need for mechanical attachment of the stator (20).

FIG. 2 also shows slots to accommodate the coils that flare in the direction of the rotor. This flare angle, chosen between the edge of the tooth and the other side of the slot, makes it possible to adjust the coil's inductance.

Of course, the angle between the axes (A₁, A₂) of the wound teeth (21, 22) has been modified in the same way as in the previous version. To emulate optimum three-phase control, the angle must in this case be equal to 168°.

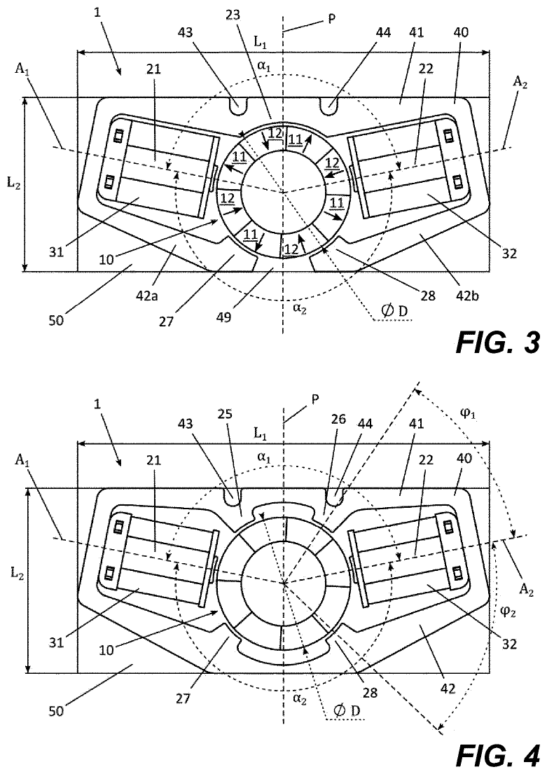

FIG. 3 shows a third variant of the present disclosure. It differs from the embodiment shown in FIG. 1 in that the most open angular sector (α₂) is devoid of magnetic and mechanical continuity (42), but has two extensions (42a, 42b) of the peripheral belt (40), separated by a clearance (49) to ensure magnetic flux return between the wound teeth (21, 22) and the rotor (10), each of these extensions being terminated by an unwound tooth (27, 28),

This configuration is particularly useful when the stator width needs to be reduced. In the example shown in FIG. 1, the width of the rectangular casing (50) enclosing the stator is related, in the angular sector (α₂), to the cross-section of the magnetic and mechanical continuity (42). This section must be at least equal to half the width, w, of the teeth (21, 22) and must be spaced apart from the rotor by the distance of an air gap, e. The elimination of the magnetic and mechanical continuity, shown in FIG. 3, does away with this constraint. The rectangular casing (50) enclosing the rotor is then constrained by the angular width and positioning of the unwound teeth (27, 28), both of which are directly related to the no-current torque of the electric machine, so this structure is subject to a compromise between optimizing no-current torque and its overall dimensions. It should be noted, however, that a similar compromise can be achieved in the version shown in FIG. 1, for which it is also possible to reduce the overall dimensions of the magnetic and mechanical continuity (42) to the detriment of magnetic performance.

This configuration is also interesting in that the undercut (49) of the peripheral belt (40) located in the most open angular sector (α₂) can be used to house a magneto-sensitive probe to obtain, for example, position or cadence information for the rotor (10).

### Fourth Variant Embodiment

FIG. 4 shows a fourth variant of the present disclosure. It differs from the previous embodiment, shown in FIG. 3, in that the peripheral belt (40) is closed between the teeth (27, 28) by a magnetic and mechanical continuity (42) and in that the mechanical and magnetic continuity (41) of the most closed angular sector (α₁) is also provided with two teeth (25, 26).

This configuration is advantageous when it comes to fine-tuning the no-current torque, as it leaves several degrees of freedom for the width of the unwound teeth (25, 26, 27, 28) and their positioning relative to the adjacent wound tooth (21, 22). To achieve this optimization, the symmetry of the stator (20) with respect to the plane P is maintained, but the angular deviation (φ₁) formed between the median axis of a tooth (25, 26) of the most closed angular sector (α₁) and the median axis of the adjacent wound tooth is different from the angular deviation (φ₂) formed between the median axis of a tooth (27, 28) of the most open angular sector (α₂) and the median axis of the adjacent wound tooth. In the example shown in FIG. 4, the angular deviation (φ₁) is 45°, while the angular deviation (φ₂) is 55°. The optimum angular distances (φ₁, φ₂) depend directly on the polarity of the rotor, but as a general rule, one of these angles should be less than or equal to 45°, while the other should be greater than 45°.

The variants shown in FIGS. 1 to 4 are by no means limiting with respect to the present disclosure, and the person skilled in the art could judiciously combine one or more of the aforementioned features. For example, the rotor polarity could be changed and the stator structure adapted to obtain the stated benefits, e.g., A structure with only one magnetic continuity, as shown in FIG. 3, but with two teeth. Alternatively, a 6-pole magnetic rotor (11, 12), which is not shown, could easily be chosen, and would then adopt an angle of 150° located between the axes (A₁, A₂) of the wound teeth (21, 22).

A concrete example of the variants shown in FIGS. 1 to 4 for the aforementioned applications would typically have a rotor diameter D of 11.85 mm, a length L₁ of 36.5 mm and a width L₂ of 16.15 mm for the version with 8 magnetized poles (11, 12) and 15.35 mm for the version with 10 magnetized poles (11, 12). For the 8-pole version, an L₂/L₁ ratio=0.44 and a D/L₂ ratio=0.73 is therefore obtained, and for the 10-pole version an L₂/L₁ ratio=0.42 and a D/L₂ ratio=0.77.

### Mechatronics Integration

The present disclosure also relates to a mechatronic assembly with one of the following variants:
1. Actuator-integrated motor with or without reducer;
2. Actuator-integrated motor with gear reduction; and
3. Motor integrated into an actuator with linear transformation.

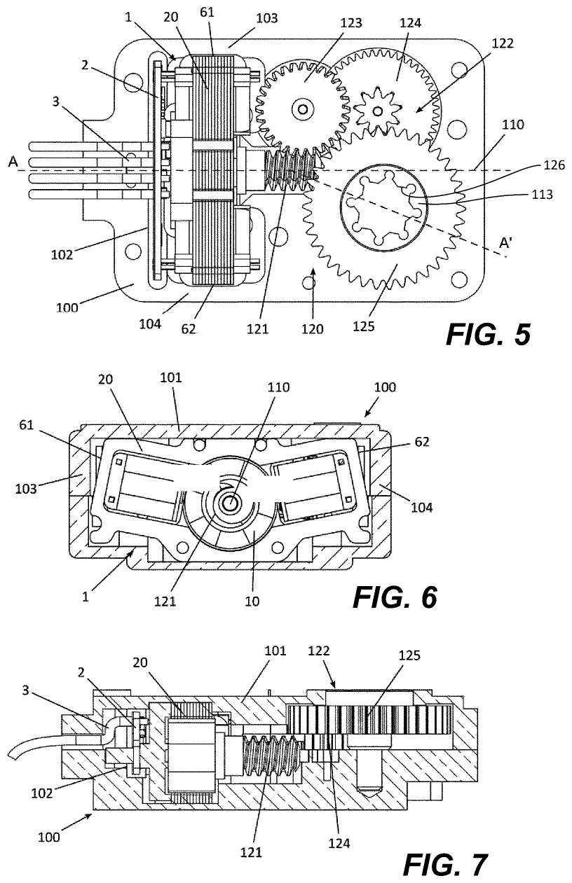

According to an example shown by FIGS. 5, 6 and 7, the electric motor (1) according to the present disclosure is associated with a motion reduction gear train (120), the whole being integrated into a housing (100) to form a very compact actuator designed to motorize, for example, air-conditioning shutters. FIG. 5 shows a front view wherein the upper cover (101) of the housing has been removed, FIG. 6 shows a side cross-sectional view of the actuator at the electric motor output and parallel to the lamination plane of the stator laminations (20), and FIG. 7 shows a longitudinal cross-sectional view, of the housing only, along the broken axis AA′, which makes it possible to appreciate the positioning of the stator (20) and the guiding of several moving parts of the gearbox. In this embodiment, the motor is positioned in the housing (100) in a transverse plane, parallel to a side face (102) of the housing (100), in contrast to conventional integral-motor actuators where the motor is arranged so that the rotor axis (110) is perpendicular to the bottom of the housing and to the output axis of the actuator. “Integral-motor actuator” is understood to mean an actuator wherein the motor and gearbox are not integrated components that are then assembled, but a very compact actuator wherein a single housing directly integrates the gearbox and electric motor components without an intermediate housing.

The rotor shaft (110) is coupled to a worm screw (121) that drives the first gear element (123), that is, a pinion/gearwheel assembly, of a spur gear subassembly (122) of the motion reducer (120), the axes of rotation of the various gear elements (123, 124, 125) of the spur gear subassembly (122) being parallel and all perpendicular to the axis of rotation of the rotor (10). The last gear element of the spur gear subassembly (122) is an output wheel (113) through which a polygonal coupling slot (126) passes to connect it to the member to be driven by the actuator. A printed circuit board (2) is located between the motor (1) and the side face (102). The lateral flanks (61, 62) of the stator (20), along its long length, adjoin the longitudinal walls (103, 104) of the housing, so that the motor and its electronics occupy the entire distal space of the housing (100), with the motion reducer (120) extending into the proximal space of the housing (100). A connector (3) soldered to the printed circuit board (2) passes through an opening in the side face (102). The clever coupling between the rotor shaft (10) and the motion reducer (120) by way of a worm screw (121) makes the actuator irreversible and thus prevents unintentional movements of the member to be driven. This is difficult to achieve with prior art solutions, when it is also necessary to maintain a particular form factor, for which the size of the actuator along the direction of its output axis. The result is a highly compact, high-performance actuator 59 mm long, 42 mm wide and just 20 mm thick in the direction of its output axis.

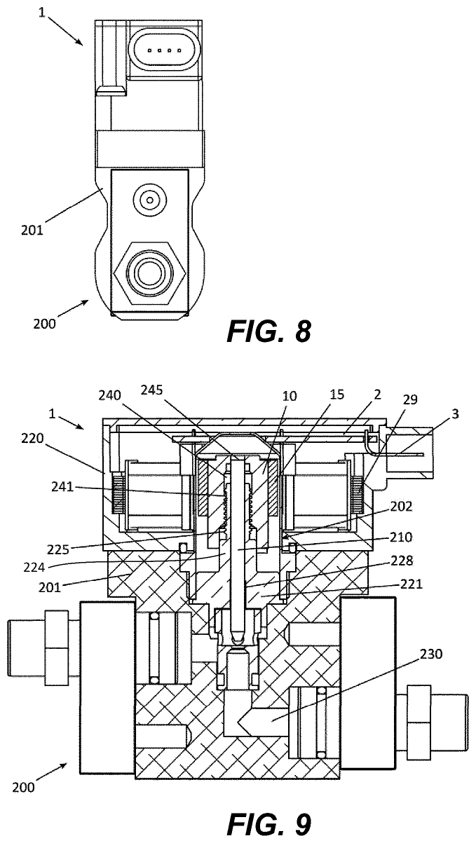

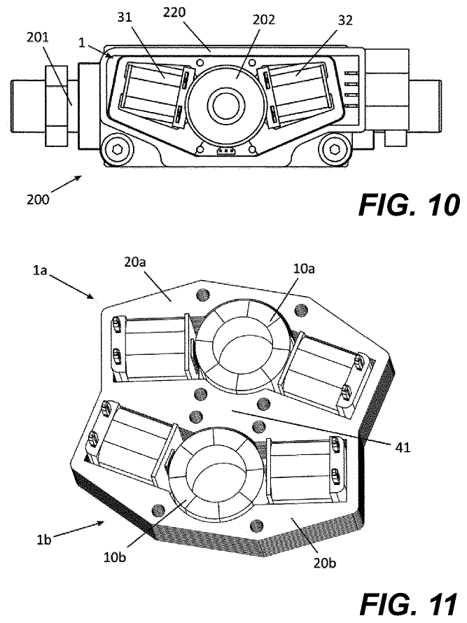

FIGS. 8 to 10 show an application of the motor according to the present disclosure in order to produce a fluid valve (200). This embodiment is similar to the known prior art of valve actuators with submerged rotor (10), in that the electric motor (1) is positioned transversely above the valve body (201), the rotor (10) being secured to a needle (210) is integrated in a sealed cartridge (202), provided with its guiding means, which is screwed directly onto the valve body (201). The stator (20), integrated into a housing (220), can be fitted to the valve body (201) once the cartridge (202) has been assembled and all leak tests have been carried out in a controlled environment. The rotor (10) has an internal cavity (240) provided with a tapping (241) engaging with a thread (225) of an axial protuberance (224) of the base of the cartridge (221). The needle (210) is attached to the axial end (245) of the rotor, opposite the valve body (201), and extends through the internal cavity (240) of the rotor. The axial protuberance (224) of the base of the cartridge (221) is provided with a longitudinal bore (226) for guiding the rotor (10) in cooperation with the needle (210). The needle (210) passes through the longitudinal bore (228) into the valve body (201), sealing the fluid-carrying valve duct (230) as it moves to the end of its stroke. The linear travel of the needle (210) is achieved by rotating the rotor (10) through the power supply to the coils (31, 32), thus screwing the rotor onto the axial protuberance of the base of the cartridge, resulting in a helical displacement movement of the rotor (10) and the needle (210) secured thereto. The rotor (10), which moves linearly during its stroke, is fitted with a magnetized ring (15) with a height equal to the thickness of the stator laminated pack (29) plus the axial displacement distance of the needle (210), so as to ensure identical magnetic performance over the entire opening stroke. Incorporating the present disclosure into this type of valve drastically reduces the space required for motorization. Indeed, as shown in FIG. 10, the very elongated shape of the electric motor (1) advantageously allows, when oriented in the direction of the valve duct (230), to increase the valve's overall dimensions only in the direction of the axis of the needle (210) and thus to form a very compact assembly.

### Fourth Variant Embodiment

FIG. 11 shows a variant of the present disclosure wherein two motors (1a and 1b) are mechanically linked by their stators (20a and 20b) cut from the same lamination pack. This embodiment is advantageous for highly compact applications where two closely spaced shafts need to be driven independently in rotation. Here, the two rotors (10a and 10b) are separated by a distance less than the length of the assembly. In this embodiment, the two stators adjoin one another at their most closed angular sector so as to form a mirror symmetry, but the present disclosure is not limited to this embodiment and the stators (20a and 20b) could also be linked, one on the side of the most open angular sector and the other on the side of the most closed angular sector, or both on the side of the most open angular sector. As one possible variant, a larger number of motors could be juxtaposed so as to drive a desired number of nearby shafts in independent rotation.

1. A two-phase brushless electric motor having a rotor and a stator, the stator including a stack of cut ferromagnetic laminations having two wound teeth each extending along a median radial axis, the median radial axes being coplanar, a cross-section of the stator being inscribed within a rectangle having a length L₁ and a width L₂, each of the wound teeth being surrounded by a coil respectively powered by one and the other of the phases, the rotor comprising three, four or five pairs of magnetic poles, the magnetic poles being radially magnetized in alternating directions, wherein the median radial axes form an angular sector therebetween that extends over an angle of between 145° and 180° and the stator has at least one mechanical and magnetic continuity extending between the two wound teeth.

2. The two-phase brushless electric motor according of claim 1, wherein the median radial axes form an angle of 157.5° with one another, the rotor having four pairs of poles.

3. The two-phase brushless electric motor of claim 1, wherein the median radial axes form an angle of 162° with one another, the rotor having five pairs of poles.

4. The two-phase brushless electric motor of claim 1, wherein the median radial axes form an angle with one another such that two coils are electrically phase-shifted by 120°.

5. The two-phase brushless electric motor of claim 1, wherein the stator has a second mechanical and magnetic continuity, one or other of the mechanical and magnetic continuities forming at least one continuous unwound tooth, the first and second mechanical and magnetic continuities extending on either side of the rotor between the two wound teeth, the first and second mechanical and magnetic continuities being of different angular widths.

6. The two-phase brushless electric motor of claim 5, wherein the second of the mechanical and magnetic continuities forms a single unwound continuous tooth.

7. The two-phase brushless electric motor of claim 4, wherein the median radial axis of each of the unwound continuous tooth or teeth is equidistant from the median radial axes.

8. The two-phase brushless electric motor of claim 4, wherein the angular width of the continuous unwound tooth or teeth is between 60° and 130°.

9. The two-phase brushless electric motor of claim 1, wherein a mechanical and magnetic continuity forms two unwound teeth, the median radial axis of each of the unwound teeth forming an angle greater than 45° with the median radial axis of the nearest wound tooth.

10. The two-phase brushless electric motor of claim 9, wherein the mechanical and magnetic continuity forming two unwound teeth is located in the least extended angular sector separating the median radial axes.

11. The two-phase brushless electric motor of claim 1, wherein the stator has a discontinuity extending between the two wound teeth on the side opposition the mechanical and magnetic continuity.

12. The two-phase brushless electric motor of claim 1, wherein a ratio of a diameter D of the rotor to the length L₁ of the rotor is greater than 50%.

13. The two-phase brushless electric motor of claim 1, wherein a ratio of the width L₂ to the length L₁ of the stator outer casing is between 0.4 and 0.6.

14. The two-phase brushless electric motor of claim 13, wherein the ratio of the width L₂ to the length L₁ of the stator outer casing is between 0.4 and 0.5.

15. The two-phase brushless electric motor of claim 1, wherein the rotor is coupled to a worm screw constituting a first module of a motion transformation.

16. The two-phase brushless electric motor of claim 15, wherein the motion transformation is a rotary to linear transformation for controlling linear displacement of an output member.

17. The two-phase brushless electric motor of claim 16, wherein the output member is a needle.

18. The two-phase brushless electric motor of claim 15, wherein the motion transformation includes a linear displacement collinear with the rotor axis.

19. The two-phase brushless electric motor of claim 15, wherein the motion transformation is a rotary to rotary transformation for controlling rotation of an output shaft.

20. The two-phase brushless electric motor of claim 15, wherein an output shaft is oriented in a direction perpendicular to the direction of the axis of the rotor.

21. A mechatronic system comprising a brushless electric motor and a substantially parallelepiped housing, wherein the motor is according to claim 1 and the rotor axis is oriented along the long length of a parallelepiped casing delimiting the substantially parallelepiped housing.

22. The mechatronic system of claim 21, further comprising a printed circuit board arranged between the motor and the housing, the face of the printed circuit board having a connector passing through a cutout provided in the transverse face of the housing.
